(19) United States
(12) Patent Application Publication
(10) Pub. No.: US 2020/0318671 A1
(43) Pub. Date: Oct. 8, 2020

(54) FASTENER AND USE OF A FASTENER

(71) Applicant: A. RAYMOND ET CIE, Grenoble (FR)

(72) Inventor: Marvin Alexander JOCHUM, Efringen-Kirchen (DE)

(21) Appl. No.: 16/761,907

(22) PCT Filed: Nov. 15, 2018
(86) PCT No.: PCT/EP2018/081435

§ 371 Date: May 6, 2020

(30) Foreign Application Priority Data
Nov. 16, 2017 (DE) 10 2017 010 602.9

(51) Int. Cl. F16B 11/00; B60R 16/08; B60R 16/02; B60N 3/04; B60R 13/02; B60R 13/04

(52) U.S. Cl. CPC F16B 11/00; B60R 16/08; B60R 16/0215; B60N 3/046; B60R 13/04; B60R 13/0206; B60R 13/0243; B60R 13/0212; B60R 13/0237

(57) ABSTRACT

Disclosed is a fastener for fastening a part to another part, the fastener comprising a sleeve and a bolt, with the bolt being configured to be inserted into the sleeve. The bolt and/or the sleeve or an element, which is located on or can be attached to the bolt and/or the sleeve, is/are configured for holding the part, the bolt being held in the sleeve in at least two positions which are mutually spaced apart along the longitudinal axis of the sleeve, between which positions the bolt can be translationally moved. The bolt and the sleeve are configured so as to allow rotation of the bolt in the first position relative to the sleeve and to prevent rotation in the second position.

### CROSS-REFERENCE TO RELATED APPLICATIONS

This application is the National Stage of International Application No. PCT/EP2018/081435, filed on 15 Nov. 2018, which claims priority to and all advantages of German Patent Application No. 102017010602.9, filed on 16 Nov. 2017, the content of which is hereby incorporated by reference.

### FIELD OF THE INVENTION

The invention relates to a fastener for fastening a part to another part.

### BACKGROUND OF THE INVENTION

When fastening a part to another part, it may be necessary to design the fastener in such a way that the fastener permits a rotational movement of the part, in particular with respect to the longitudinal axis of the fastener.

DE 10 2004 014 593 A1 discloses a device for fastening to a carrier part provided with a threaded bolt having a threaded part that can be screwed onto a threaded section of the threaded bolt and having an abutment area against which the threaded part rests in an end position. The threaded part has a first engagement structure and a rotatable drive part. The drive part has a second engagement structure which engages with the first engagement structure, wherein the threaded part and the drive part are movable relative to each other in the radial direction at least before taking up the end position.

It has been found that the structure of the known devices is complicated and/or handling is difficult.

### SUMMARY OF THE INVENTION

The object of the invention is therefore to provide a fastener for fastening a part to another part, which at least partially improves the disadvantages known from the prior art. In particular, a fastener of simple structure is to be provided which makes good handling possible.

The fastener has a sleeve and a bolt, the bolt being configured to be inserted into the sleeve, wherein the bolt and/or the sleeve or an element of the fastener, which is located on or attachable to the bolt or the sleeve, is configured for holding the part, wherein the bolt is held in the sleeve in at least a first position and a second position spaced apart from one other in the longitudinal axis of the sleeve, between which the bolt can be moved translationally in the sleeve, and wherein the bolt and the sleeve are configured such that in the first position the bolt can be rotated relative to the sleeve and in the second position rotation of the bolt relative to the sleeve is prevented. Advantageous embodiments are claimed in the subclaims and become apparent from the following description of the invention.

The idea underlying the invention is to create a fastener for fastening a part to another part, in which two components of the fastener, which have plug-in elements in the form of a sleeve and a bolt, are held in two positions relative to each other, and the two components are movable relative to each other in a translational movement between these two positions along the longitudinal axis of the sleeve and the bolt, wherein in one of the two positions the two components can be rotated relative to each other about the longitudinal axis and in the other position the relative rotation of the two components relative to each other about the longitudinal axis is prevented. Simplified handling can thus be achieved. Holding in the at least two positions creates at least one position in which the two components are rotatable relative to each other, in order, for example, to simplify the mounting of the part to be mounted and/or to allow the two components to be protected against loss relative to each other even when the rotatability of the two components relative to each other about the longitudinal axis is given. Furthermore, the two components can be manufactured in a simplified manner, so that the design of the fastener can be made simpler. In addition, the translational movement between the two positions makes it possible to use no or a simple tool which, for example, does not have to be adapted to an outer or inner contour of a component.

The invention creates a fastener for fastening a part to another part. As introduced above, the fastener comprises a sleeve and a bolt. The bolt is configured to be inserted into the sleeve, wherein the bolt or/and the sleeve or an element located or attachable to the bolt or the sleeve is configured to hold the part. The bolt is held in the sleeve in two positions spaced apart from each other along the longitudinal axis of the sleeve, with more than two positions also being possible. Between the two positions, the bolt is translationally movable in the sleeve, and the bolt and the sleeve are configured such that a rotation of the bolt in the first position relative to the sleeve is permitted and a rotation is prevented in the second position. Within the meaning of the invention, the rotation is a rotational movement about the longitudinal axis of the bolt and/or the sleeve, wherein, in particular, a rotation to be prevented in the second position can be seen, whose axis of rotation runs in the direction of the direction of movement in which the bolt and the sleeve move relative to each other in order to move from the first into the second or from the second into the first position.

A fastener can be a device by which a part can be fastened to another part, in particular during installation in vehicle or automobile construction, a vehicle within the meaning of the invention comprising a mobile means of transport which can be moved only or predominantly on land, only or predominantly in or on the water and/or only or predominantly in the air. A vehicle within the meaning of the invention is in particular a non-track-bound land vehicle, in particular a motor vehicle.

A part may be any component or element. The part can be a line, in particular for fluids in the form of hoses or for electric current in the form of cables. The element is generally selected from elements which are to be mounted or fastened in the area of the vehicle body. The part can in particular be an elongated component, with flat components also being possible. The part may be a panel, a floor mat, a cover, a bumper strip, paneling or the like. The part may be an element to be mounted or fastened inside or outside an at least partially enclosed space in the vehicle.

Within the meaning of the invention, the other part can be the same or a similar component as the aforementioned part. Two similar or identical parts can thus be fastened relative to each other by means of the fastener. The two parts can differ from each other in particular in size. The other part can also be a carrier part which is a part of a vehicle. The carrier part may be a section of the chassis of the vehicle, a door or a wheel of the vehicle. The invention likewise relates to use as trim-strip fasteners and also as fasteners of decorative strips, electronic components or, for example, of the headliner in a vehicle.

A sleeve may be an elongated hollow-body section or section having an opening and/or a hole for receiving a bolt. The opening or the hole can extend in particular in the direction of the longitudinal axis. The sleeve may be a section of a component. The sleeve may comprise a relatively inflexible material. The sleeve may comprise or be made of metal, plastic or a composite material. The length of the sleeve can in particular be greater than the inner diameter of the opening or of the hole. The cross-section of the opening or of the hole is not necessarily circular, but a circular shape is not excluded either.

A bolt may be a rod-shaped or pin-shaped structural element, the length of which along the longitudinal axis can be greater than the diameter. The term bolt within the meaning of the invention thus comprises an elongated element which can substantially have the shape of a pin or rod. What is essential within the meaning of the invention is the elongated extension along a longitudinal axis, wherein the diameter or the contour of the bolt perpendicular to its longitudinal extension can be smaller than the extension in the longitudinal direction. The bolt may assume any contour in the longitudinal direction, provided this is not excluded or otherwise specified within the context of the invention. A circular shape of the bolt is not absolutely necessary, but neither is it excluded.

Sleeve and bolt within the meaning of the invention are two interacting plug-in elements which, although in one embodiment they can be moved relative to each other along the longitudinal axis of the sleeve and bolt even without a tool in order to carry out the assembly, they can nevertheless generally be moved relative to each other along the longitudinal axis of the sleeve and bolt using a tool.

An element for holding can be a fastening element for a part, with which a fixation of the element on the part is possible. The term “element for holding” thus comprises an element which offers the possibility of a part being accommodated on or fixed to the fastener at least in sections. The bolt or sleeve of the fastener can within the meaning of the invention be fixed or fastened to the part by means of the element for holding in order to perform the function of holding. The element for holding can be configured integrally with the sleeve or the bolt. The element for holding can also be present as a separate component from the bolt or the sleeve, wherein the element for holding can be connected to or fastened onto the sleeve or the bolt. The “element for holding” can be configured in particular as a hose clip, latching receptacle, holder, fastener. The bolt could also be a classic welding stud in a vehicle (provided its geometry is adjusted accordingly); the sleeve could then be made of a plastic.

When the term “a” and corresponding grammatical adaptations to the gender of the noun designated in the following in the term is used in the description and claims, this term will comprise the singular and the plural of the noun in question. The term “a” and corresponding grammatical adaptations to the noun designated in the following for the term will generally not exclude the provision of several elements designated by the noun. If a numerical indication is used for a number, then the mention of this number comprises exactly the number, but also, alternatively or additionally, a larger number of the elements respectively designated by means of the noun.

The term “holding” in the sense, according to the invention, of the bolt being held in the sleeve in at least two positions spaced apart from each other on the longitudinal axis of the sleeve comprises a positioning or arrangement of the bolt and the sleeve relative to each other such that the bolt is held in the sleeve substantially at the position relative to the longitudinal axis. This can provide a protection against loss of the bolt and sleeve relative to each other, in particular in both positions. The term “holding” comprises the formation of a positive fit in both positions which prevents a translational movement of the bolt to the sleeve in both directions of the longitudinal axis of the sleeve and bolt. The term “holding” within the meaning of the description can comprise a latching of the bolt and sleeve in these two positions which are spaced apart from each other along the longitudinal axis and can be overcome by means of a tensile or compressive load. In both positions, a stop against a translational movement in each case in one of the two directions of the longitudinal axis—and thus two stops—can be provided in each case, which prevents or makes a translational movement of the bolt relative to the sleeve difficult. One of these stops must be overcome in order, for example, to move from the first position to the second position or to achieve a separation of the sleeve and bolt from the first position (withdrawal of the bolt from the sleeve). It can be provided that the bolt and the sleeve at their respective positions in the longitudinal axial direction along the longitudinal axis of the bolt and sleeve is freely movable within a certain range along the longitudinal axis, i.e., that a play is possible, so that the sleeve and the bolt can move relative to each other in the longitudinal axial extension of the two, wherein this does not lead to any significant change in position and thus, within the meaning of the invention, a position not only denotes a specific, clearly defined orientation of the sleeve and the bolt in relation to the longitudinal extension or longitudinal axis, but also an area in which the sleeve and bolt are in a position relative to each other in relation to the longitudinal extension.

Within the meaning of the invention, the two positions can differ from each other in that the bolt can be arranged at different depths in the sleeve and a positive fit or a latching has to be overcome in order to change between the two positions. In particular, it can be provided that the first position is a position in which the bolt is arranged less deeply in the sleeve and a rotational movement is permitted in this position. In the second position, which is typically a position in which the bolt is arranged more deeply in the sleeve, the rotational movement can be blocked or prevented.

A “translational movement” within the meaning of the invention is a movement carried out along a straight line, in which the rotational movement proportion or the proportion of a rotation is vanishingly small. The possibility provided according to the invention for the translational movement of the bolt in the sleeve does not necessarily presuppose a free mobility of the bolt in the sleeve in the translational direction, but rather includes the effect that a hindrance, for example a positive fit, is overcome with the translational movement or for enabling the translational movement.

In a specific embodiment, the bolt also in the first position is secured in the sleeve against being pulled out of the sleeve. There is a loss protection.

In a specific embodiment, the bolt and the sleeve are configured to form a positive fit of the bolt and the sleeve with each other acting in the longitudinal axial extension and that can in particular be overcome, in order in particular to enable holding in the two positions. The positive fit can be overcome through a flexibility or elasticity of the sleeve and/or bolt. The formation of a positive fit for “holding” the bolt in the sleeve is possible in a simplified manner with a suitable geometry or structure and/or choice of material for the sleeve and bolt, at least in the area where the positive fit is achieved. Different requirements with regard to the setting of a minimum or maximum force for releasing the positive fit can be met. The positive fit acts in particular in the direction of the translational movement between the two positions.

In a specific embodiment, the bolt or the sleeve has two recesses and/or projections spaced from one another in the longitudinal direction, the extension of which along the longitudinal axis is adapted to the extension of a projection/recess along the longitudinal axis on the other component of the fastener, i.e. the sleeve or the bolt. A projection is understood in particular to mean a body which is embodied on the sleeve or the bolt and which projects opposite to sections of the sleeve or of the bolt adjacent thereto. A recess is understood in particular to mean a material omission which is embodied on the sleeve or the bolt and which creates a blind hole or a groove with opposite to sections of the sleeve or of the bolt adjacent thereto. Stop faces are formed on the projection and/or on the walls delimiting the recess, whose surface normal has an angle greater than 15°, alternatively greater than 30°, alternatively greater than 45° to the longitudinal axis, wherein curved surfaces in particular can also be provided. On the projection and/or on the walls delimiting the recess, stop faces are formed whose surface normal has an angle of less than 90°, alternatively greater than 80°, alternatively greater than 60° to the longitudinal axis. The angular position of the stop faces can simplify overcoming the positive fit in which the stop faces generally participate. One of the stop faces acts in one direction along the longitudinal axis and another in the opposite direction. In specific embodiments, stop faces are provided on the sleeve and bolt which abut each other when the bolt is in the first position in the sleeve. for example, two stop faces are provided on the bolt, one of which acts in one direction along the longitudinal axis and the other in the opposite direction, and in addition two stop faces are provided on the sleeve, one of which acts in one direction along the longitudinal axis and the other in the opposite direction, each of the stop faces of the bolt abutting one stop face of the sleeve when the bolt is in the first position in the sleeve.

By the use of projections or recesses on both elements, it is possible to define positions in which the projections interact with the recesses and a projection has to be withdrawn from a recess in order to reach another position. By means of a simple design element in the form of a projection transverse to the longitudinal axis, in particular at least partially extending in the circumferential direction, on either of the sleeve or the bolt and a corresponding recess transverse to the longitudinal axis, in particular at least partially extending in the circumferential direction, on the other of the two components of the fastener, the function for holding can be implemented in one position. The formation of projections or recesses on both components of the fastener can be handled easily and the design well implemented. The projections and/or recesses can be formed circumferentially unbroken about the longitudinal axis, but it is also possible to form one or more projections and/or recesses only in sections along the circumference of a longitudinal axis.

In a specific embodiment, rotation in the second position can be prevented by means of an in particular releasable positive fit achieved in this position acting transversely to the longitudinal axis, in particular in the circumferential direction about the longitudinal axis. The two positive fits are here independent of each other and it can be achieved that the positive fits do not affect each other, since different means for this can be provided in each case. The positive fit for preventing rotation acts in the direction transverse to the movement of the bolt relative to the sleeve or rotationally about the direction of movement of the bolt during assembly.

In a specific embodiment, the positive fit for preventing rotation about the longitudinal axis of the bolt relative to the sleeve can be made possible by means of projections, so that the bolt and the sleeve each have at least one projection, and the projections for preventing the rotation of the sleeve and bolt relative to each other engage with each other, in particular the projections of one element engage in the interspaces between projections of the other element. However, it can also be provided for a single projection to be provided on one element, which is pushed into a recess in the other element, typically a recess open at the end, into which the projection can be pushed in by a movement along the longitudinal axis of the sleeve. In various embodiments it may be desirable to use projections which have a stop face for interaction with a projection of the other element, which extends in the radial direction from the longitudinal axis and which face in the circumferential direction about the longitudinal axis. One or more projections may be provided to form the stop face for a clockwise and an anticlockwise rotation.

Interspaces which extend in the direction of the longitudinal axis of the sleeve or of the bolt are generally provided between the projections. The interspaces may be open at the ends, so that a projection provided on the respective other element can be pushed into the interspace with a movement along the longitudinal axis of the sleeve. The interspace can in particular have an insertion aid in the form of inclines in order to facilitate the insertion of the projections.

In a specific embodiment, a plurality of projections are provided distributed circumferentially in the sleeve and/or on the bolt. In this way, a plurality of positions can be provided for the sleeve relative to the bolt in which the rotation of the two relative to each other is prevented. A circumferential distribution of projections allows a positive fit acting in different rotational positions in the circumferential direction to take place and/or the force for preventing or suppressing the rotational movement to be increased. In particular, it can be provided for the number of recesses configured to accommodate projections to be greater than the number of projections. Projections on the one element and interspaces on the other element for receiving projections on the first element can be present on the bolt or on the sleeve distributed at equidistant angular intervals about the longitudinal axis.

In a specific embodiment, the projections are arranged at the head end of the sleeve and/or bolt. Within the meaning of the invention, the term “head end” is understood to mean an end region which in the case of the sleeve is adjacent to the entry region for the bolt and in the case of the bolt is a region which is spaced apart from the free end of the bolt or adjacent to the element for holding the part. In this way, a latching or a positive fit can be effected in the vicinity of any forces which may occur which are exerted on the part. Stress on the bolt over its entire length is thus reduced.

In a specific embodiment, the projections are arranged substantially centrally with respect to the longitudinal extension on the sleeve and/or bolt, so that a position can be selected that is independent of the end regions of the sleeve or bolt.

In a specific embodiment, the projections are arranged at the foot end of the bolt and/or the sleeve. The term “foot end” denotes an end region of the sleeve or bolt which is present for the sleeve at a distance from the insertion region for the bolt and which for the bolt relates to the region which first enters the opening region of the sleeve. A simple design development is thereby possible.

In a specific embodiment, the sleeve and/or the bolt has a plastic, a metal and/or a composite material.

The term “has” within the meaning of the invention also includes the term “consists of” so that it is also stated by means of the said verb that the respective element mentioned consists of a specific material, wherein naturally unavoidable impurities and insignificant admixtures likewise fall under the term “consists of”.

The use of a suitable material may offer the advantage of meeting different requirements. For example, the use of a plastic offers the advantage that a fastener of low weight is possible. With a suitable choice of plastic, a chemical resistance, temperature resistance and/or a long service life are also possible.

The invention also provides a use of a fastener for fastening a part to another part, the fastener having a sleeve and a bolt and the bolt being configured to be inserted into the sleeve, wherein the bolt or sleeve or an element located or attachable to the sleeve or bolt is configured to hold the part. A holding, in particular in the form of a loss protection feature, is used to hold the bolt in the sleeve in one of two positions spaced apart from each other along the longitudinal axis of the sleeve, between which the bolt is translationally movable in the sleeve, the bolt being rotatable in the first position relative to the sleeve about the longitudinal axis, and rotation being prevented in the second position.

### BRIEF DESCRIPTION OF THE DRAWINGS

The invention is explained in more detail below with reference to drawings which show embodiments of the invention. The drawings show:

FIG. 1a shows a perspective oblique side view of a bolt of a fastener;

FIG. 1b shows the bolt according to FIG. 1a with an element for holding a part according to a first embodiment;

FIG. 2a shows a perspective oblique side view of a sleeve of a fastener;

FIG. 2b shows a perspective view according to FIG. 2a with an element for holding a part according to a first embodiment;

FIG. 3 shows a partially transparent perspective view of a fastener with a bolt according to

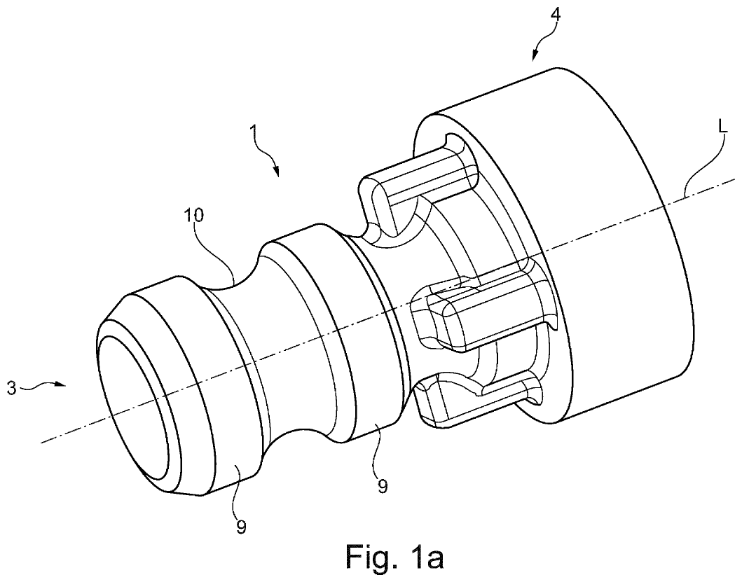

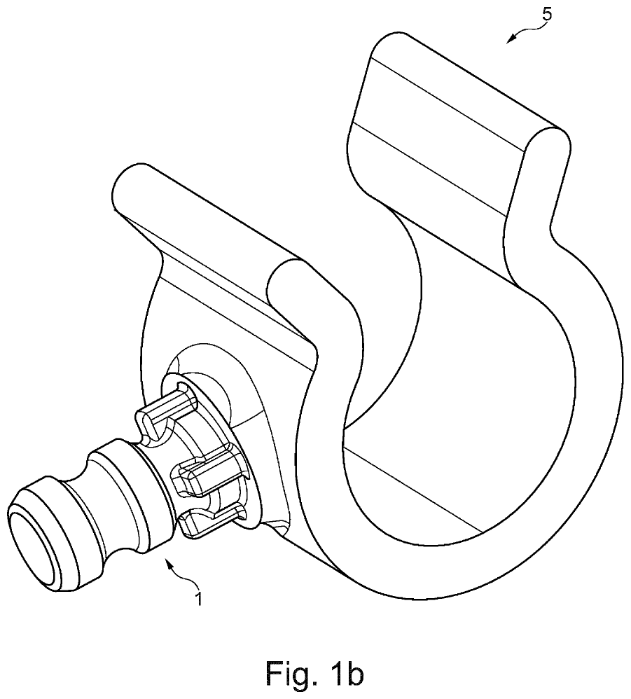

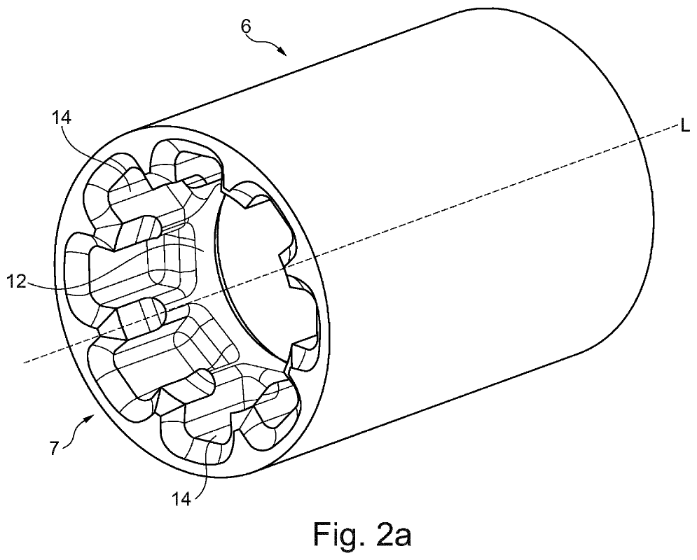

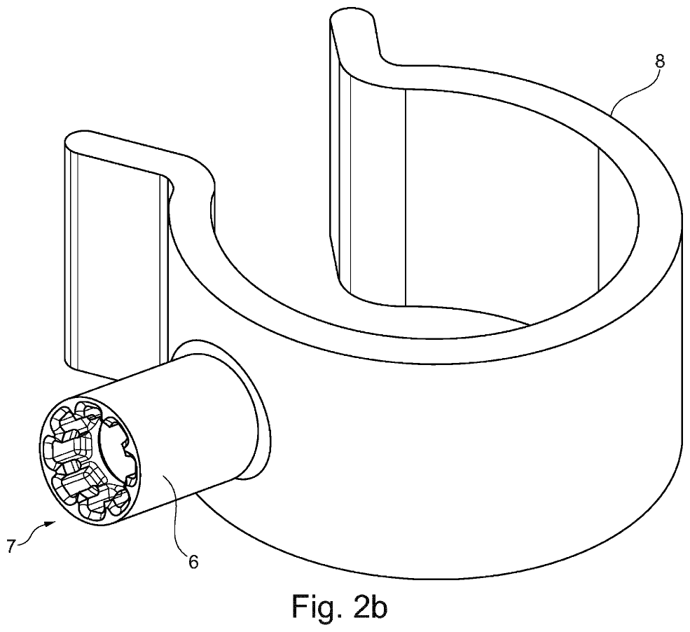

FIG. 1a and a sleeve according to FIG. 2a in a first position;

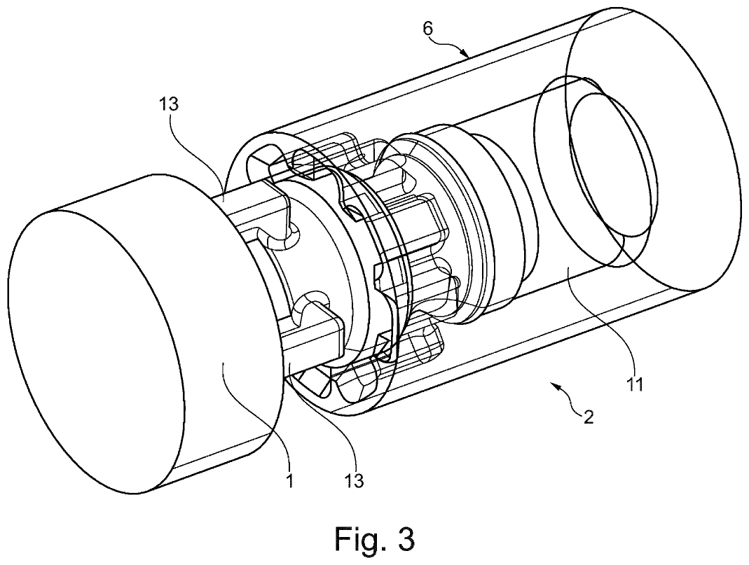

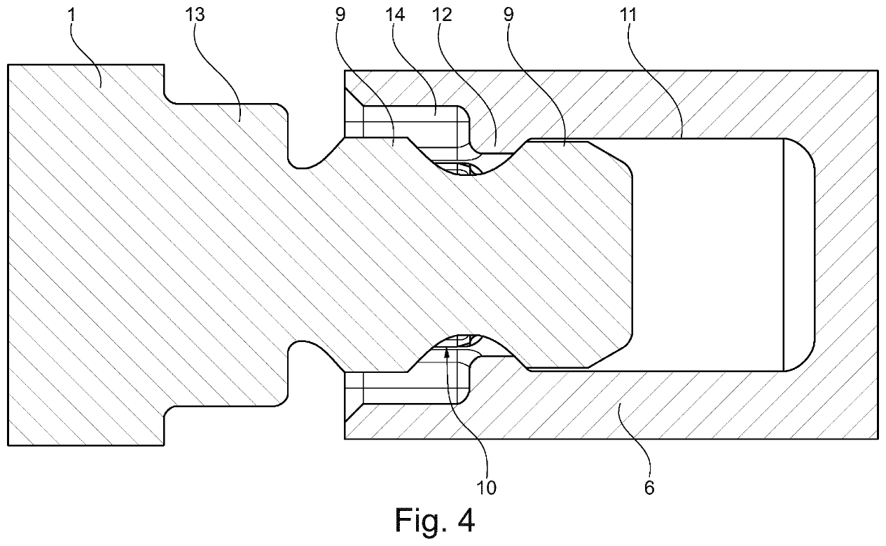

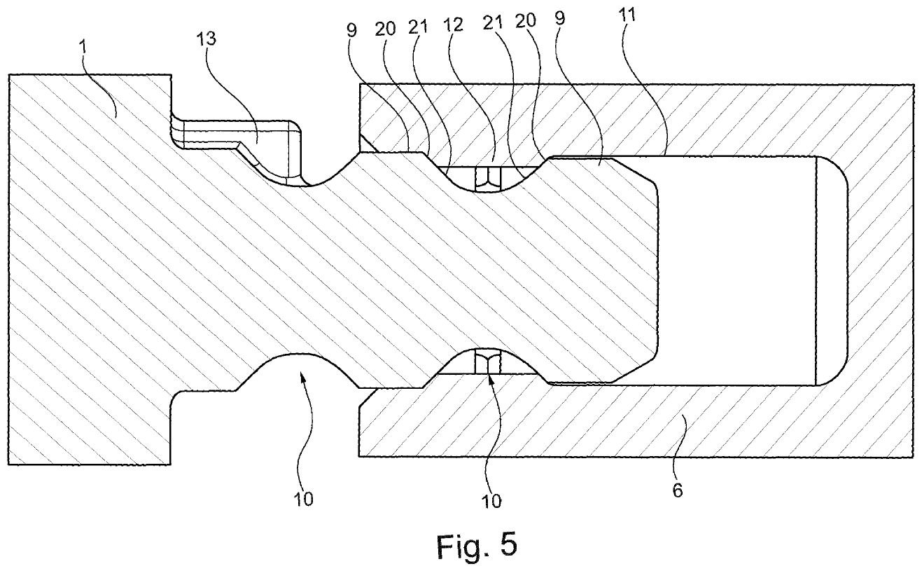

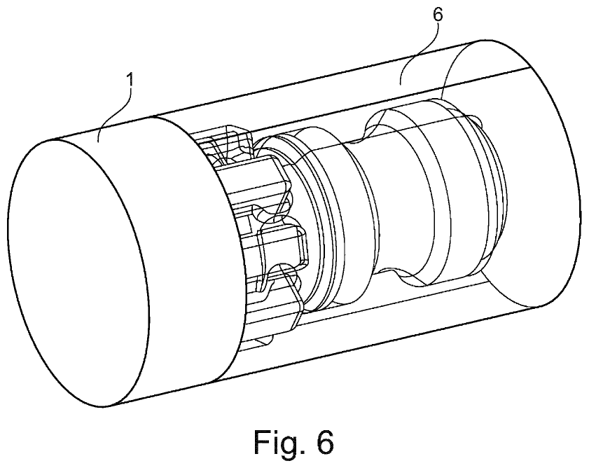

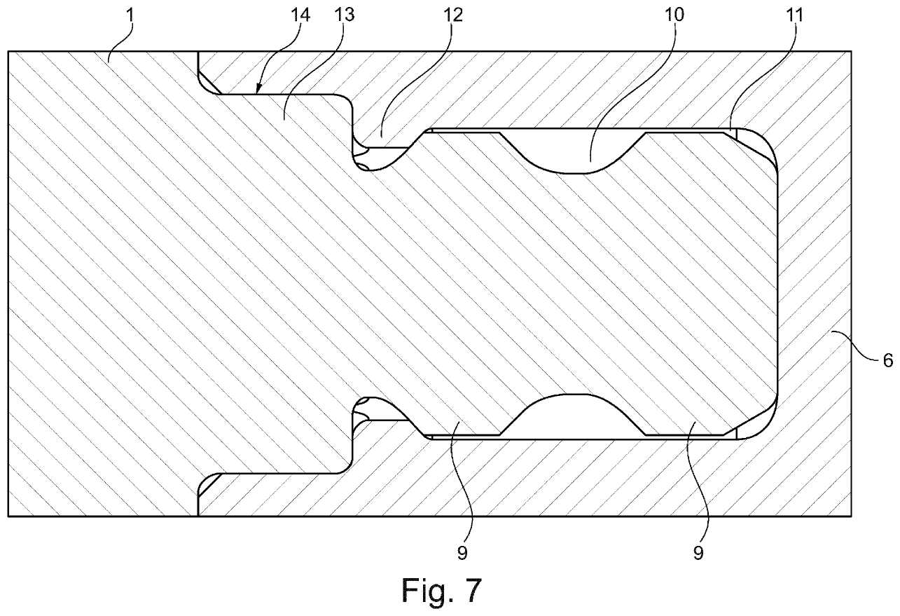

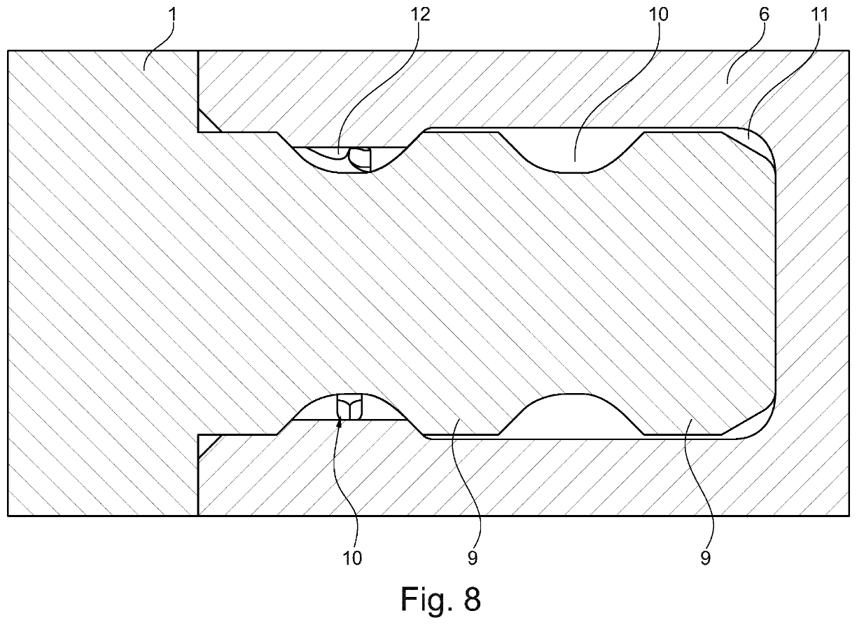

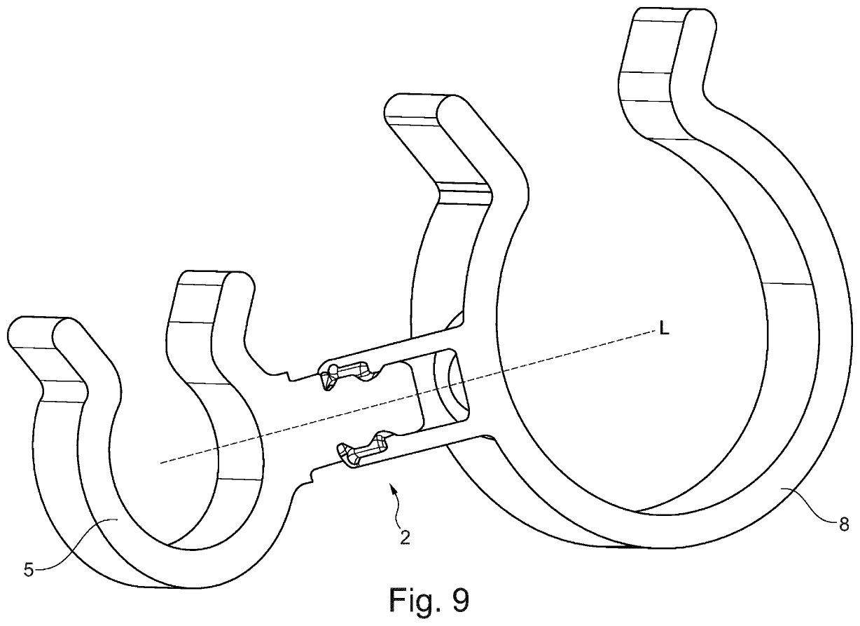

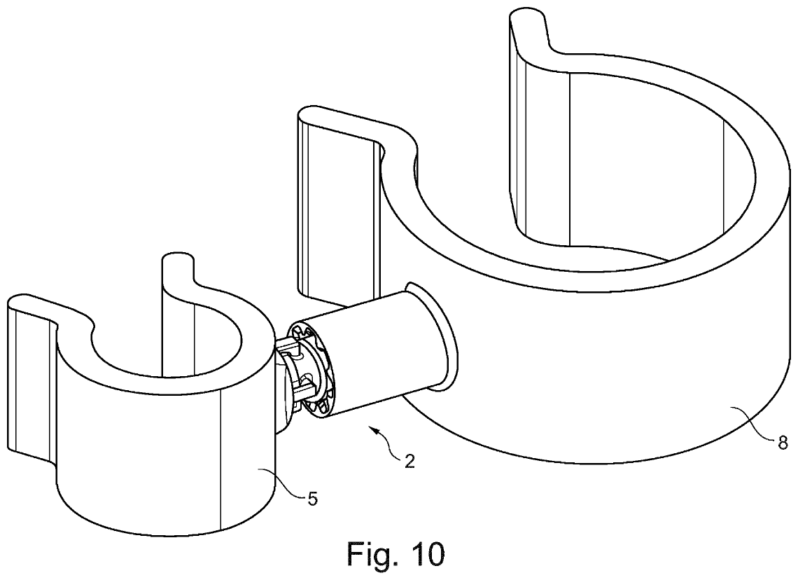

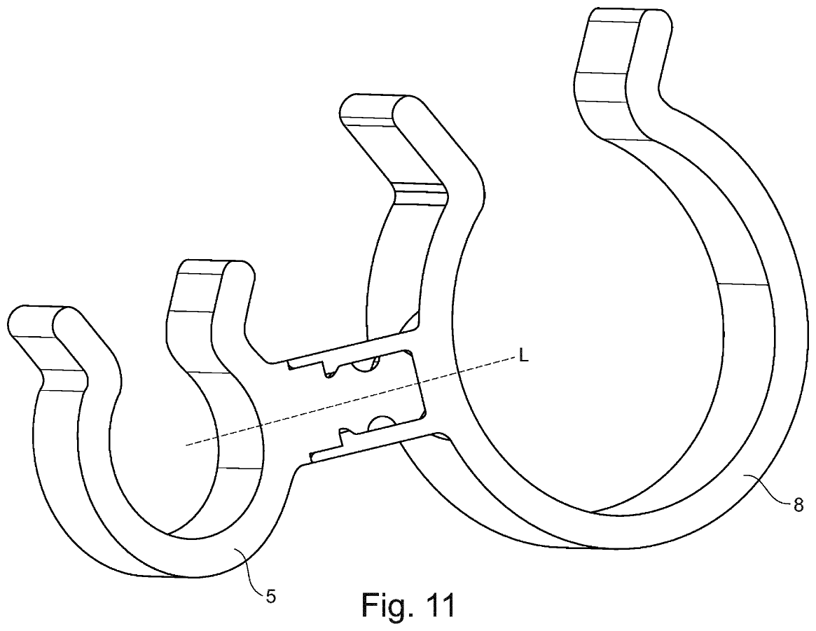

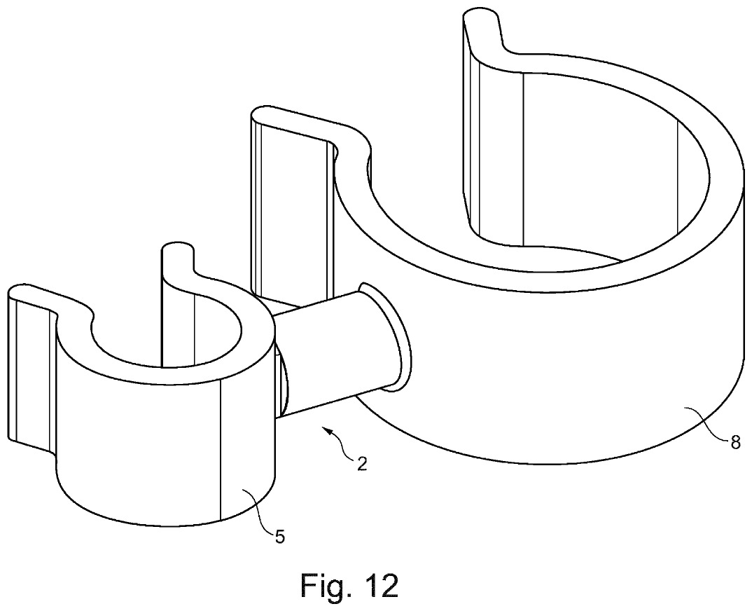

FIG. 4 shows a sectional view according to FIG. 3 in a plane through the longitudinal axis and a projection on the bolt;

FIG. 5 shows a sectional view according to FIG. 3 in a plane through the longitudinal axis and next to a projection on the bolt;

FIG. 6 shows a partially transparent perspective view of the fastener from FIG. 3 in a second position;

FIG. 7 shows a sectional view according to FIG. 6 in a plane through the longitudinal axis and a projection of the bolt;

FIG. 8 shows a sectional view according to FIG. 6 in a plane through the longitudinal axis and next to a projection of the bolt;

FIG. 9 shows a sectional view of an embodiment of a fastener in a first position;

FIG. 10 shows a perspective view of the embodiment of the fastener according to FIG. 9 in a first position;

FIG. 11 shows a sectional view of the embodiment of a fastener according to FIG. 9 in a second position, and

FIG. 12 shows a perspective view of the embodiment of the fastener according to FIG. 9 in a second position.

### DETAILED DESCRIPTION

Referring to FIGS. 1-12, wherein like numerals indicate corresponding parts throughout the several views, bolt is illustrated and generally designated 1. In particular, FIG. 1a shows a perspective oblique side view of a bolt 1 of a fastener 2 (see FIG. 3). The bolt 1 has an elongated shape, the longitudinal axis L of the bolt 1 being drawn as a dashed line in FIG. 1 a. The bolt 1 has a free end 3, which is shown on the left in FIG. 1 a. The free end 3 is arranged on the pin 1 at the foot end. The bolt 1 also has an end 4 at the head end and an end on which an element for holding 5 a part can be arranged or is located (FIG. 1 b). The element for holding 5 is formed on the bolt 1 in FIG. 1 b.

FIG. 2a shows a perspective oblique side view of a sleeve 6 of a fastener 2. The sleeve 6 has a longitudinal axis L shown as a dashed line.

The bolt 1 and the sleeve 6 are configured in such a way that the bolt 1 with its free end 3 can be inserted into an opening 7 of the sleeve 6. The bolt 1 and the sleeve 6 here interact, as described below.

Firstly, FIG. 2b shows a perspective view of the sleeve 6 with an element formed on the sleeve 6 for holding 8 a (further) part, wherein the element for holding 8 is configured as a (further) hose clip.

The bolt 1 and the sleeve 6 interact as plug-in elements. The bolt 1 and sleeve 6 have interacting means to hold the bolt 1 to the sleeve 6 at two positions spaced apart from each other in the extension of the longitudinal axis L. In the first position (FIG. 3), the bolt 1 is pushed less deeply into the sleeve 6 than in the second position (FIG. 6). The holding of the bolt 1 in the sleeve 4 is implemented by means of a plurality of positive fits between the bolt 1 and the sleeve 6 that act along the longitudinal axis L.

The bolt 1 has recesses 10 formed at least partially circumferentially about the longitudinal axis L. The reduction in the cross-section at the recesses 10 results in projections 9, one of which is arranged between the two recesses 10. The two recesses 10 are configured substantially identically and have substantially the same length in particular in the extension along the longitudinal axis L. In addition, the depth of the recesses 10 is the same. For interaction with the bolt 1, the sleeve 6 has a region in the channel 11 extending from the opening 7, whose cross-section is reduced so that a projection 12 of the sleeve 6 projecting into the channel 11 is formed which is formed at least partially unbroken circumferentially about the longitudinal axis L. The projection 12 of the sleeve 6 is adapted to the extension of the recess 10 along the longitudinal axis L of the bolt 1.

In the exemplary embodiment shown in FIG. 3 the bolt 1 is located at a first position relative to the sleeve 6. FIG. 5 shows a sectional view in which the projection 12 of the sleeve 6 is arranged precisely in the recess 10. There is a positive fit, acting along the longitudinal axis L, between the recess 10 of the bolt 1 and the projection 12 of the sleeve 6, that holds the bolt 1 in the first position relative to the sleeve 6. For this purpose, abutment faces 20 running at an angle to the longitudinal axis L are provided on the projection 12 and come into abutment with curved abutment faces 21 delimiting the recess 10.

In order to move the bolt 1 from the first position (FIG. 3) relative to the sleeve 6, a force must be applied to overcome the positive fit. Should a sufficient tensile force be applied to the bolt 1 in relation to the sleeve 6 in the exemplary embodiment illustrated in FIGS. 3 to 5, the bolt 1 can be pulled out of the sleeve 6 and bolt 1 and sleeve 6 can be separated from each other. On the other hand, if a sufficient compressive force is applied to the bolt 1, the bolt 1 will be able to move from the first position (FIG. 3) into the second position shown in FIGS. 6 to 8.

Also in the second position there is a positive fit acting in the longitudinal axial direction between the projection 12 of the sleeve 6 and a recess 10 of the bolt 1. The bolt 1 is held in the sleeve 6 or held in the second position. In addition, the end 3 at the foot end of the bolt 1 abuts at its end face against the channel base delimiting the channel 11. If a sufficient tensile force is exerted on the bolt 1, the positive fit between the recess 10 and the projection 12 can be overcome and the bolt 1 can be brought back to the first position (cf. FIG. 3).

In the first position (FIG. 3), the bolt 1 is freely rotatable in the sleeve 6 about the longitudinal axis L. In the second position (FIG. 6), the rotation of the bolt 1 relative to the sleeve 6 about the longitudinal axis L is prevented, this being achieved by the formation of a positive fit. In the second position, projections 13 of the bolt 1 engage in recess 14 of the sleeve 6 (interspaces between projections on the sleeve). The rotational movement about the longitudinal axis L is prevented. For this purpose, the recesses 14 of the sleeve 6 and the projections 13 of the bolt 1 have abutment faces which in particular have a section which runs in particular transversely to the longitudinal axis L, in particular radially to the longitudinal axis L.

FIGS. 9, 10, 11 and 12 show an exemplary embodiment of a fastener 2 in which the elements for holding 5, 8 take the form of clip bodies and form an opening on one side, through which tubes or lines can be inserted with resilient bending of the clip walls. To simplify the insertion of the tubes or lines, obliquely inwardly facing insertion walls are provided on the free ends of the clip walls on both sides of the opening. The bolt 1 and the sleeve 6 form a section of a bridging piece by means of which the clip bodies are connected to each other. In the first position of the fastener 2 shown in FIGS. 9, the two clip bodies can be turned about the longitudinal axis L so that the clip bodies can be adapted to the particular local conditions when tubes or lines are installed. The clip bodies can be adjusted or adapted to any angle of inclination of tubes or lines running next to each other. In the second position of the fastener 2 shown in FIG. 10, the rotation of the clip bodies relative to each other is prevented.

The terms “comprising” or “comprise” are used herein in their broadest sense to mean and encompass the notions of “including,” “include,” “consist(ing) essentially of,” and “consist(ing) of. The use of “for example,” “e.g.,” “such as,” and “including” to list illustrative examples does not limit to only the listed examples. Thus, “for example” or “such as” means “for example, but not limited to” or “such as, but not limited to” and encompasses other similar or equivalent examples. The term “about” as used herein serves to reasonably encompass or describe minor variations in numerical values measured by instrumental analysis or as a result of sample handling. Such minor variations may be in the order of ±0-25, ±0-10, ±0-5, or ±0-2.5, % of the numerical values. Further, The term “about” applies to both numerical values when associated with a range of values. Moreover, the term “about” may apply to numerical values even when not explicitly stated.

Generally, as used herein a hyphen “-” or dash “−” in a range of values is “to” or “through”; a “>” is “above” or “greater-than”; a “≥” is “at least” or “greater-than or equal to”; a “<” is “below” or “less-than”; and a “≤” is “at most” or “less-than or equal to.” On an individual basis, each of the aforementioned applications for patent, patents, and/or patent application publications, is expressly incorporated herein by reference in its entirety in one or more non-limiting embodiments.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

The present invention has been described herein in an illustrative manner, and it is to be understood that the terminology which has been used is intended to be in the nature of words of description rather than of limitation. Many modifications and variations of the present invention are possible in light of the above teachings. The present invention may be practiced otherwise than as specifically described within the scope of the appended claims. The subject matter of all combinations of independent and dependent claims, both single and multiple dependent, is herein expressly contemplated.

What is claimed is:

1. A fastener for fastening a part to another part, the fastener having a sleeve and a bolt, the bolt being configured to be inserted into the sleeve, wherein the bolt and/or the sleeve or an element of the fastener, which is located on or attachable to the bolt or the sleeve, is configured for holding the part, wherein the bolt is held in the sleeve in at least a first position and a second position spaced apart from one other in the longitudinal axis of the sleeve, between which the bolt can be moved translationally in the sleeve, and wherein the bolt and the sleeve are configured such that in the first position the bolt can be rotated relative to the sleeve and in the second position rotation of the bolt relative to the sleeve is prevented.

2. The fastener according to claim 1, wherein the bolt and the sleeve are dconfigured in such a way that the bolt is secured against being pulled out of the sleeve.

3. The fastener according to claim 1, wherein the sleeve and the bolt are configured in such a way that in the first and second positions a positive fit acting along the longitudinal axis is formed between them.

4. The fastener according to claim 1, wherein the boltor the sleeve has a projection, whose extension along the longitudinal axis is adapted to an extension of a recess along the longitudinal axis of the sleeve or bolt.

5. The fastener according to claim 1, wherein the bolt and the sleeve are configured to form in the second position a positive fit acting in the direction transverse to the longitudinal axis and/or in a circumferential direction of the sleeve.

6. The fastener according to claim 5, wherein the bolt and the sleeve have elements in the form of a projection and a recess for forming the positive fit.

7. The fastener according to claim 1, wherein the bolt and the sleeve at their respective positions are freely movable along the longitudinal axis within a region in the longitudinal axial direction along the longitudinal axis of the bolt and sleeve so that the sleeve and the bolt can move relative to each other in the longitudinal axial extension of the sleeve and the bolt.

8. The fastener according to claim 6, wherein a plurality of projections are provided circumferentially distributed on the sleeve and/or on the bolt.

9. The fastener according to claim 6, wherein the projections are arranged:
a) at a head end;
b) substantially centrally with respect to the longitudinal axis; and/or
c) at a foot end
on the bolt and/or sleeve.

10. The fastener according to claim 1, wherein the sleeve and/or the bolt comprises a plastic, a metal and/or a composite material.

11. A method of fastening a part to another part, comprising fastening the part to another part with the fastener of claim 1.
